(19) United States
(12) Patent Application Publication
(10) Pub. No.: US 2026/0357981 A1
(43) Pub. Date: Nov. 12, 2026

(54) PROCEDURE FOR REDUCING SOOT FORMATION IN A POX REACTOR DURING TRANSIENTS

(71) Applicant: CASALE SA, Lugano (CH)

(72) Inventors: Luca ZANICHELLI, Milano (IT); Giacomo COLMEGNA, Massagno (CH)

(21) Appl. No.: 19/486,625

(22) PCT Filed: May 28, 2024
(86) PCT No.: PCT/EP2024/064654

§ 371 Date: Nov. 21, 2025

(30) Foreign Application Priority Data
Jun. 1, 2023 (EP) 23176796.3

(51) Int. Cl. F23N 1/00

(52) U.S. Cl. CPC F23N 1/00; F23N 2227/02; F23N 2239/04

(57) ABSTRACT

A procedure for a conducting a transient of a burner of a partial oxidation reactor, such as a startup or a shutdown, wherein the burner in a normal condition operates with a carbon-containing gaseous fuel and combustion of said fuel takes place in a combustion chamber in the presence of oxygen, wherein said procedure includes that said fuel is replaced with hydrogen during the transient to reduce formation of soot.

### FIELD OF THE INVENTION

The invention is in the field of partial oxidation reforming (POX) reactors for the production of synthesis gas. The invention relates to a procedure for reducing the formation of soot during transients.

### PRIOR ART

The production of several chemical commodities of industrial interest, such as methanol, ammonia and synthetic fuel for example, requires conversion of a hydrocarbon source into a synthesis gas (syngas). The syngas in most cases is a mixture of carbon monoxide, carbon dioxide and hydrogen. The hydrocarbon source is most commonly natural gas but other sources may be used such as coal or biomass.

Partial oxidation reforming, usually shortened POX, is a major process for methane reforming along with steam reforming, catalytic partial oxidation (CPO) and autothermal reforming (ATR). In general terms, a POX process involves that a fuel gas is brought into contact with an oxidizer. The fuel gas may be for example natural gas or another hydrocarbon-containing gas, or a partially reformed gas produced in a previous reforming step, for example in a primary reformer. The oxidizer is an oxygen-containing stream such as air, oxygen or oxygen-enriched air.

A partial oxidation reactor includes a refractory lined pressure vessel and a process burner. The process burner is generally mounted on top of the reactor. The lined pressure vessel delimits a combustion chamber (also termed reaction chamber) wherein the partial oxidation reactions take place. The process burner is designed to properly introduce the fuel stream and the oxidizer stream into the combustion chamber. For example, a known kind of burner is designed to produce coaxial streams of fuel and oxidizer.

The combustion in a partial oxidation reactor is by definition a rich combustion, for example the partial oxidation reforming of methane is generally conducted to achieve H2 to CO ratio from 1.0 to 2.5 in the gas. In a condition of excess fuel, the formation of soot is a challenge. With the current technique, the formation of soot during normal operation can be controlled and virtually eliminated by a proper selection of the process parameters and burner aerodynamic design; during transients such as start-up and shut-down, however, it remains a problem.

A typical start-up procedure includes the following steps. First, a proper preheating is necessary to avoid any thermal cracks of the refractory walls of the combustion chamber. This pre heating takes place with a lean flame, namely under full combustion conditions. The pre-heating lean flame may be generated with the main burner or with a dedicated start-up burner. Once the pre heating is complete the following sequence takes place: the pre heating flame is shut off; nitrogen and/or steam are introduced in the chamber to remove all excess of oxidant; then the hydrocarbon fuel and oxygen are sent to the unit, forming a flammable mixture; as soon as the flammable mixture hits the hot refractory wall, self-ignition takes place.

In the preheating step, the refractory walls are heated to very high temperature (>1200 °C). The fuel (typically a hydrocarbon) must be introduced before the oxygen because otherwise a lean flame might be established with subsequence switch from lean to rich which is not desirable. Therefore, the fuel enters a hot environment where very little oxidant is available (essentially only some steam); as a consequence, the fuel inevitably cracks and forms soot when it comes into contact with the hot walls of the combustion chamber. A considerable amount of soot is formed also when oxygen is injected and the flame starts, until the unit reaches full temperature.

In broad terms, the startup requires a pre-heating of the combustion chamber due to the considerable thermal inertia of the refractory walls. Preheating is generally performed with an auxiliary burner. In order to maintain the temperature and the combustion process under control, it is mandatory to introduce the fuel first and then the oxygen. There is therefore a certain time interval during which the flame is rich, the fuel can contact the very hot walls of the chamber, accordingly the conditions are favorable to the formation of soot.

Therefore, the soot formation is inevitable even with a perfectly timed procedure.

A similar problem emerges with the shut-down procedure. In a shut-down sequence, oxygen is shut off but the fuel is kept flowing for a while to allow a reasonable time for flushing the combustion chamber and to make sure that the flame is off, for safety reasons; the drawback is that some fuel enters a chamber where no oxidant is available and inevitably cracks producing soot.

A change of load of the burner may be another significant source of soot. During a change of load, the burner may produce more soot compared to steady operation. The load of the burner can be defined as the amount of fuel reacted in the combustion chamber. The need to operate equipment at variable load is becoming more important with the use of renewable sources of energy subject to fluctuation.

The formation of soot is undesired for many reasons. The effluent gas from the POX burner is typically cooled by producing steam in a shell-and-tube heat exchanger, where the soot causes fouling of tubes and reduces the heat exchange coefficient. Downstream the POX burner, an equipment to remove soot from the gas may be required for environmental reasons, which increases cost.

WO 2023/061786 describes a reactor for partial oxidation of hydrocarbons fitted with a burner.

U.S. Pat. No 3,982,910 discloses a hydrogen-rich gas generator wherein, while the generator is starting up, hydrogen fuel is injected into the combustion chamber as a fine atomized spray. As disclosed in col. 4, at startup a liquid hydrocarbon fuel from a source (50) is pumped through a two-way valve (52) into the burner; the burner has a startup nozzle (54) which emits a spray of liquid droplets into the combustion chamber (56). During startup, air/fuel ratio is maintained above the normal design value.

### SUMMARY OF THE INVENTION

The invention addresses the problem of how to mitigate the formation of soot during transients of a POX burner and more specifically during start up and shut down.

The problem is solved with a procedure according to the claims.

The invention uses hydrogen to replace temporarily the conventional carbon-containing fuel during a transient. The term transient denotes a transitional event during which the burner deviates from normal operation; transients of interest include a startup, a shutdown or a major change of load.

In a start-up procedure, after a preheating step of the combustion chamber, a rich flame is initially ignited and stabilized by a hydrogen-oxygen flame which is inherently free from soot production. When a target temperature is reached, the hydrogen is gradually replaced with the carbon-containing fuel and the condition of normal operation is reached without a significant formation of soot. In a shut-down procedure, hydrogen is first added to the hydrocarbon fuel and subsequently the feed of hydrocarbon fuel is discontinued, leaving a hydrogen-oxygen flame. This shut-down procedure avoids a persistent condition of excess fuel during which soot is generated. During a change of load, hydrogen can act temporarily as a soot suppression agent.

A procedure according to the invention may include the step of reaching a condition wherein a combustion of hydrogen takes place in the combustion chamber, in absence of the carbon-containing fuel. The combustion of hydrogen during the transient is most preferably a rich combustion. This condition may be reached before feeding the fuel in the event of a start-up, or after the feed of said fuel has been cut, in the event of a shut-down.

In the start-up procedure, the pre-heating of the combustion chamber is performed preferably with a lean flame of the carbon-containing fuel. In this phase, the lean flame does not produce a significant amount of soot. The preheating may be performed until the combustion chamber and the walls thereof have reached a target temperature.

The invention allows to eliminate the condition of temporary rich combustion of a hydrocarbon fuel, or injection of hydrocarbon fuel in a hot chamber with no or little oxygen, responsible for the formation of soot in the prior art. In the invention, the rich combustion of a hydrocarbon fuel is replaced with a rich combustion of hydrogen which is naturally immune from the problem of soot formation as it does not contain carbon. It can be said that the invention provides a virtually soot-less startup or shutdown of the POX burner.

### DESCRIPTION OF THE INVENTION

The invention discloses a procedure for a conducting a transient of a burner of a partial oxidation reactor. The burner is arranged to feed a fuel and an oxidizer to a combustion chamber of said partial oxidation reactor. The burner in a normal condition operates with a carbon-containing gaseous fuel and combustion of said fuel takes place in the combustion chamber of the reactor in the presence of oxygen. According to the invention, said procedure includes that said fuel is replaced with hydrogen during the transient. In a first interesting application, the transient is a start-up and the procedure includes the following sequence:
the combustion chamber is preheated; a hydrogen stream is admitted in the preheated combustion chamber in absence of said carbon-containing fuel, and an oxygen-containing stream is admitted in the combustion chamber so that combustion of hydrogen and oxygen starts and a hydrogen flame is established in the combustion chamber;
after the above step, a stream of the carbon-containing fuel is admitted in the combustion chamber so that a mixed flame of hydrogen and of said fuel is formed;
after the above step, the flow rate of carbon-containing fuel is gradually increased and the flow rate of hydrogen is decreased until a condition wherein hydrogen is no longer fed to the combustion chamber and the carbon-containing fuel reaches a target flow rate corresponding to normal operation.

The preheating of the combustion chamber may be performed with a lean flame of the carbon-containing fuel.

In a second application, the transient is a shut-down and the procedure includes the following sequence:
starting from a condition of combustion of the carbon-containing fuel in the combustion chamber, the flow rate of said fuel is decreased and hydrogen is admitted in the combustion chamber, so that hydrogen replaces the carbon-containing fuel in the combustion process, until a condition where no carbon-containing fuel is admitted in the combustion chamber and the combustion is fueled by hydrogen;
the oxygen feed is cut, so that the combustion process extinguishes for lack of oxygen;
the hydrogen feed is cut so that the shut-down of the burner is completed.

In another application, the transient is a change of load of the burner and injection of hydrogen in the combustion chamber is used to suppress formation of soot. A change of load in most cases is regarded as a ramp from a current load to a new load. The injection of hydrogen can be started before the ramp of the load change starts and stopped after the new load has been reached.

Hydrogen may be injected in the combustion chamber with a dedicated hydrogen injection line. The line is equipped with suitable control means such as flowmeters and a control valve. Hydrogen can be introduced in the form of a stream of pure hydrogen or as a hydrogen-rich gas.

Said hydrogen line is generally not intended for continuous use. During normal operation at a constant load, the hydrogen line remains typically unused unless excess hydrogen is available in the plant. Said line may be used intermittently to suppress soot formation during load changes.

The carbon-containing fuel can be a fossil fuel, such as natural gas, or a synthesis gas.

The oxygen for combustion can be introduced in the combustion chamber by means of any of: a stream of pure oxygen, a stream of oxygen-enriched air or an air stream.

During the entire transient, the flame in the combustion chamber is preferably a rich flame. The condition of rich flame or lean flame is defined in accordance with the equivalence ratio. The equivalence ratio (ER) is calculated as the actual fuel-to-oxidizer ratio over the stoichiometric fuel-to-oxidizer ratio, namely:

ER=(F/O)/(F/O)ₛₜ

wherein (F/O) is the fuel to oxidizer ratio and “st” denote the stoichiometric condition. A rich flame has ER>1.0. In the above definition of the equivalence ratio, the term “fuel” denotes both the hydrogen and, if any, the carbon-containing fuel. Preferably, the equivalence ratio during the transient is in the range 1.5 to 4.0. During the transient, the flame can be a hydrogen flame or a mixed flame. A hydrogen flame is obtained when burning a fuel which is essentially hydrogen or pure hydrogen; a mixed flame is obtained with mixed hydrogen and carbon-containing fuel.

During the transient, the combustion is preferably controlled to keep the temperature in the combustion chamber below than 1500 °C. The temperature in the combustion chamber may be controlled by injection of steam.

The hydrogen or hydrogen-rich mixture used in the invention could be sourced from an existing source or pipeline inside the chemical complex where the POX is installed, if available. If not available, a dedicated sourcing infrastructure is set up to provide this flow. Examples of a sourcing infrastructure include: a dedicated pressurized tank (or tank farm); a tube trailer(s) sourced from outside the chemical site; an ammonia cracker. A hydrogen tank, if provided, is preferably sized to store a sufficient amount of hydrogen for at least two startup or shutdown procedures.

Depending on plant configuration, a dedicated source of hydrogen (such as an ammonia cracker) may be foreseen for another process use, such as to startup a desulphurization unit. In this case hydrogen from said source may be used in the POX burner according to the present invention. The hydrogen source may be provided with a sufficient capacity to feed hydrogen for the above-mentioned process use and for the burner when required.

Preferably, during the transient, the temperature in the combustion chamber is controlled to remain below 1500 °C. The temperature in the combustion chamber may be controlled, preferably, by injection of steam.

A very interesting application of the invention concerns startups and shutdowns. During a startup, the hydrogen feed is preheated before entering the combustion chamber. Preheating can be performed with known technique. A remarkable advantage is that the POX unit is flushed with a mixture of hydrogen and steam which contain no carbon and, as such, cannot generate soot.

Once the combustion chamber has been flushed and a stable flow of hydrogen is established, the oxygen can be sent to the burner. The relative amount of oxygen and hydrogen is computed to obtain formation of a rich flame with an exit temperature compatible with the refractory and the waste heat boiler. The flame is detected and a sufficient time is given for the flame to stabilize and increase further the temperature of the POX unit. When the flame is stable and the unit has reached a target temperature, the hydrocarbon fuel can be added to the stream of hydrogen and steam entering the combustion chamber. Being that a flame is already established and oxygen is present, the hydrocarbon fuel will make little or no soot.

The addition of the fuel will result in a slight decrease of the operating temperature. Once the addition has been successfully done the hydrogen can be gradually reduced to zero while optimizing the flow of oxygen and fuel. Accordingly, the unit is brought to the operating conditions.

The following is a description of a preferred shutdown procedure. the burner is brought to a minimum load and hydrogen is added to the fuel stream. The hydrocarbon fuel is reduced and eventually set to zero. The hydrogen stream must be sufficient to guarantee that the flame is always rich.

Upon shutoff of the hydrocarbon fuel the temperature does not increase beyond the maximum allowed. Steam can also be added to moderate the temperature.

Once the hydrocarbon flow has been set to zero, the oxygen flow can be shut off switching off the flame. At this point there will be no carbon entering the chamber therefore no soot will be formed. As soon as the oxygen line has been flushed, the hydrogen flow can also be shut off.

The procedure of the invention was tested in a pilot scale. The tests evidenced that the burner can successfully stabilize the flame.

Commonly, the burner is installed vertically on top of the pressure vessel of the POX reactor. In a typical embodiment, the burner has coaxially arranged channels for the fuel and the oxidizer. The burners, especially at the tip, may be internally traversed by cooling water.

The procedure of the invention can be applied to existing burners of POX reactors. The invention may be applied to typical burners as described above, with coaxial passages for the fuel and oxidizer, either water-cooled or not. The burner may be modified by installing the hydrogen line. If not available, a suitable infrastructure for sourcing the hydrogen or hydrogen-rich mixture shall be set up.

In a preferred application, the present invention is applied to a POX reactor of an ammonia plant or of a methanol plant.

1. A procedure for a conducting a transient of a burner of a partial oxidation reactor, wherein the burner is arranged to feed a fuel and an oxidizer to a combustion chamber of said reactor, the procedure comprising:
in a normal condition, operating the burner with a carbon-containing gaseous fuel and combustion of said fuel takes place in said combustion chamber in the presence of oxygen; and
replacing said fuel with hydrogen during the transient.

2. The procedure according to claim 1 wherein the transient is a start-up and the procedure includes the following sequence:
a) the combustion chamber is preheated; a hydrogen stream is admitted in the combustion chamber of the burner after preheating of said chamber, said hydrogen stream being introduced in the preheated combustion chamber in absence of said carbon-containing fuel, and an oxygen-containing stream is admitted in the combustion chamber so that combustion of hydrogen and oxygen starts and a hydrogen flame is established in the combustion chamber;
b) after step a), a stream of the carbon-containing fuel is admitted in the combustion chamber so that a mixed flame of hydrogen and of said fuel is formed;
c) after step b), the flow rate of carbon-containing fuel is gradually increased, and the flow rate of hydrogen is decreased until a condition wherein hydrogen is no longer fed to the combustion chamber and the carbon-containing fuel reaches a target flow rate corresponding to normal operation.

3. The procedure according to claim 2 wherein the admission of fuel at step b) is started after a stable flame of hydrogen is detected in the combustion chamber and the temperature in the combustion chamber has reached a target value.

4. The procedure according to claim 2 where, in step a), the combustion chamber is preheated with a lean flame of the carbon-containing fuel.

5. The procedure according to claim 1 wherein the transient is a shut-down and the procedure includes the following sequence:
a) starting from a condition of combustion of the carbon-containing fuel in the combustion chamber, the flow rate of said fuel is decreased and hydrogen is admitted in the combustion chamber, so that hydrogen replaces the carbon-containing fuel in the combustion process, until a condition where no carbon-containing fuel is admitted in the combustion chamber and the combustion is fueled by hydrogen;
b) the oxygen feed is cut, so that the combustion process extinguishes for lack of oxygen;
c) the hydrogen feed is cut so that the shut-down of the burner is completed.

6. The procedure according to claim 1 wherein the transient is a change of load of the burner and hydrogen is injected in the combustion chamber as a soot formation suppressor.

7. The procedure according to claim 1 wherein the carbon-containing fuel is a fossil fuel, such as natural gas, or a synthesis gas.

8. The procedure according to claim 1 wherein hydrogen is introduced in the form of a stream of pure hydrogen or as a hydrogen-rich gas.

9. The procedure according to claim 1 wherein oxygen for combustion is introduced in the combustion chamber by means of any of: a stream of pure oxygen, a stream of oxygen-enriched air, an air stream.

10. The procedure according to claim 1 wherein, during the entire transient, the flame in the combustion chamber is a rich flame.

11. The procedure according to claim 10 wherein, during the transient, the burner is operated with equivalence ratio in the range 1.5 to 4.0, said equivalence ratio being defined as the ratio of the actual fuel-to-oxidizer ratio to the stoichiometric fuel-to-oxidizer ratio.

12. The procedure according to claim 1 wherein the combustion, during the transient, is controlled to keep the temperature in the combustion chamber below 1500 °C.

13. The procedure according to claim 12 wherein the temperature in the combustion chamber is controlled by injection of steam.
